(19) United States
(12) Patent Application Publication
(10) Pub. No.: US 2009/0052574 A1
(43) Pub. Date: Feb. 26, 2009

(54) MEDIA ACCESS CONTROL ADAPTATION METHOD FOR MICROWAVE INTERFERENCE

(75) Inventors: Guoqing Li, Portland, OR (US); Srikathyayani Srikanteswara, Hillsboro, OR (US); Christian Maciocco, Portland, OR (US)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/843,171

(22) Filed: Aug. 22, 2007

(51) Int. Cl. H04L 25/00

(52) U.S. Cl. 375/296

(57) ABSTRACT

Disclosed is a Media Access Control (MAC) adaptation method for adapting transmission of packets by a wireless device in response to interference in a wireless medium. On detecting interference in the wireless medium, the wireless device triggers sensing of wireless spectrum to determine presence of a periodic interference signal. A first energy level and a second energy level of the periodic interference signal are estimated and a threshold energy level is set between the first energy level and the second energy level for transmission of packets by the wireless device. Based on the threshold energy level and a current energy level in the wireless medium, the wireless device transmits packets over the wireless medium.

### FIELD OF THE DISCLOSURE

The present disclosure generally relates to packet transmissions in a wireless medium, and more particularly, to a method for adapting packet transmissions by a wireless devices in response to a microwave interference in the wireless medium.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIGS. 1A and 1B illustrate throughput performance of an 802.11 link without interference from a microwave oven signal and with interference from the microwave oven signal respectively;

FIG. 2 illustrates a variation in power of a microwave oven signal with respect to variation in distance from a source of the microwave oven signal;

FIG. 3 illustrates a microwave oven signal plotted with respect to time;

FIG. 4A illustrates change in retry counter of a wireless device with respect to variation in power of a microwave oven signal;

FIG. 4B illustrates variation in instances of packet transmissions by a wireless device in presence of a microwave oven signal;

FIG. 5 illustrates an environment in which various embodiments of the present disclosure may be practiced;

FIG. 6 is a flow diagram illustrating a method for adapting transmission of packets by a wireless device in response to interference in a wireless medium, in accordance with an embodiment of the present disclosure;

FIG. 7 depicts an exemplary environment, in accordance with an embodiment of the present disclosure;

FIG. 8 illustrates change in packet transmissions with respect to variation in power of a microwave oven signal in an exemplary environment, in accordance with an embodiment of the present disclosure;

FIG. 9 illustrates instant throughput performance of a wireless link in an exemplary environment, in accordance with an embodiment of the present disclosure; and

FIG. 10 illustrates time-average throughput performance of a wireless link in an exemplary environment, in accordance with an embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The terms “a” and “an” herein do not denote a limitation of quantity, but rather denote the presence of at least one of the referenced item.

The present disclosure provides a method for adapting transmission of packets by a wireless device in response to interference in a wireless medium. On detecting interference in the wireless medium, the wireless device triggers sensing of wireless spectrum to determine presence of a periodic interference signal. Upon determining the periodic interference signal, a first energy level and a second energy level of the periodic interference signal are estimated. On estimating the first energy level and the second energy level of the periodic interference signal, the wireless device sets a threshold energy level between the first energy level and the second energy level for transmission of packets. Based on the threshold energy level and a current energy level in the wireless medium, the wireless device transmits packets over the wireless medium.

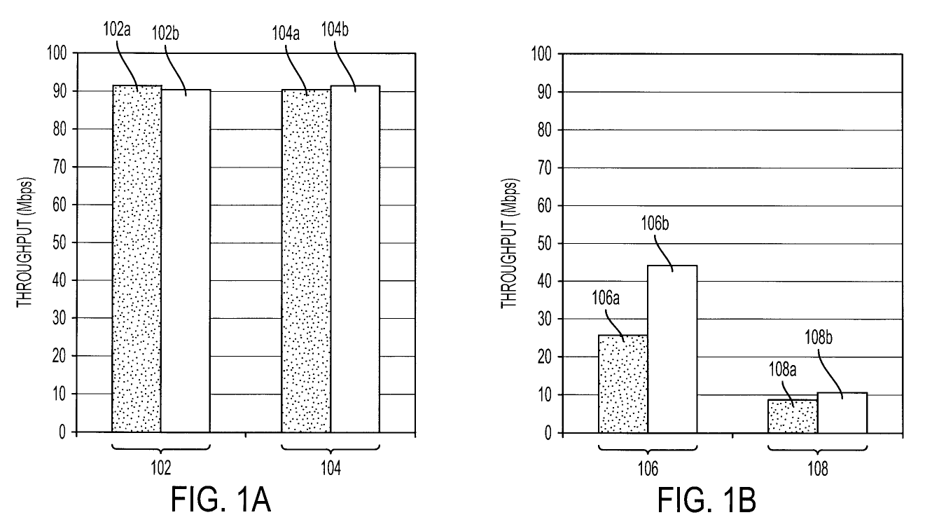

FIGS. 1A and 1B illustrate throughput performance of an 802.11 link without interference from a microwave oven signal and with interference from the microwave oven signal, respectively. The 802.11 link may be any wireless channel (such as an air medium) over which the packets are communicated between wireless devices. The throughput performance of the 802.11 link may be defined as the speed of transmission of packets over the 802.11 link and is measured in Megabits per second (Mbps) (shown as Y-axes in FIGS. 1A and 1B). FIG. 1A is a plot of throughput performance of the 802.11 link measured in an isolated house without interference from the microwave oven signal. The plot shown in FIG. 1A depicts line of sight (LOS) measurements 102 and non line of sight (NLOS) measurements 104 of throughput of the 802.11 link, respectively. The LOS measurements 102 comprise a LOS measurement 102a and a LOS measurement 102b, representing LOS measurement of the throughput of the 802.11 link performed using an omni directional antenna and a directional antenna respectively. The NLOS measurements 104 comprise a NLOS measurement 104a and a NLOS measurement 104b, representing NLOS measurement of the throughput of the 802.11 link performed using the omni directional antenna and the directional antenna respectively.

FIG. 1B is a plot of throughput performance of the 802.11 link measured in the isolated house in presence of interference from the microwave oven signal. The plot in FIG. 1B depicts a line of sight (LOS) measurement 106 and a non line of sight (NLOS) measurement 108 of throughput of the 802.11 link in presence of interference from the microwave oven signal in the isolated house. The LOS measurements 106 comprise a LOS measurement 106a and a LOS measurement 106b, respectively representing LOS measurement of the throughput of the 802.11 link performed using an omni directional antenna and a directional antenna. The NLOS measurements 108 comprise a NLOS measurement 108a and a NLOS measurement 108b, respectively representing NLOS measurement of the throughput of the 802.11 link performed using the omni directional antenna and the directional antenna. It will be evident to those skilled in the art that the microwave oven signal is a source of interference for 802.11 device operations in the 2.4 Gigahertz band. It may be observed from FIGS. 1A and 1B that the microwave oven signal degrades the throughput performance of the 802.11 link by 60 percent to 70 percent.

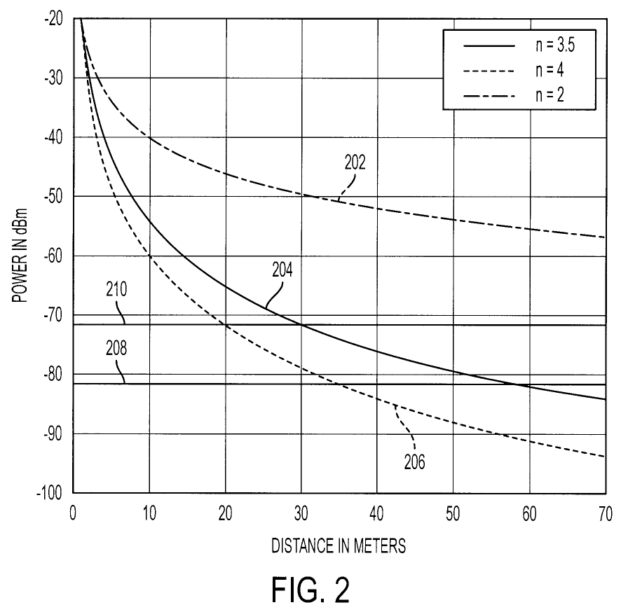

FIG. 2 illustrates a variation in power of a microwave oven signal with respect to variation in distance from a source of the microwave oven signal. In FIG. 2, the variation in power (measured in decibels and referenced to milliwatt) of the microwave oven signal is plotted with respect to distance (measured in meters) for multiple values of n which indicates the path loss exponent of the environment. The plots for values n=2, n=3.5 and n=4 are depicted as plot 202, plot 204 and plot 206, respectively. It may be observed from the plots that the microwave oven signal degrades as the distance increases. The microwave oven signal carries substantial power and may cause interference in multiple homes, as can be seen from the distance (X-axis) over which the microwave oven signal degrades in FIG. 2.

FIG. 2 further depicts a clear channel assessment threshold 208 and a power level 210. The clear channel assessment threshold 208 signifies a typical threshold energy level used by wireless devices for sensing the microwave oven signal. The power level 210 depicts receiver sensitivity at 54 Megabits per second (Mbps) and signifies an amount of power that a transceiver in a wireless device must receive for achieving a desired signal-to-noise ratio. The power level of 208 is the Clear-channel-assessment (CCA) threshold that a receiver considers the wireless channel as busy if the received power is over this threshold. It is seen that the power of a microwave oven can cause a wireless device to regard the channel as busy and thus hold off transmission, which leads to performance degradation.

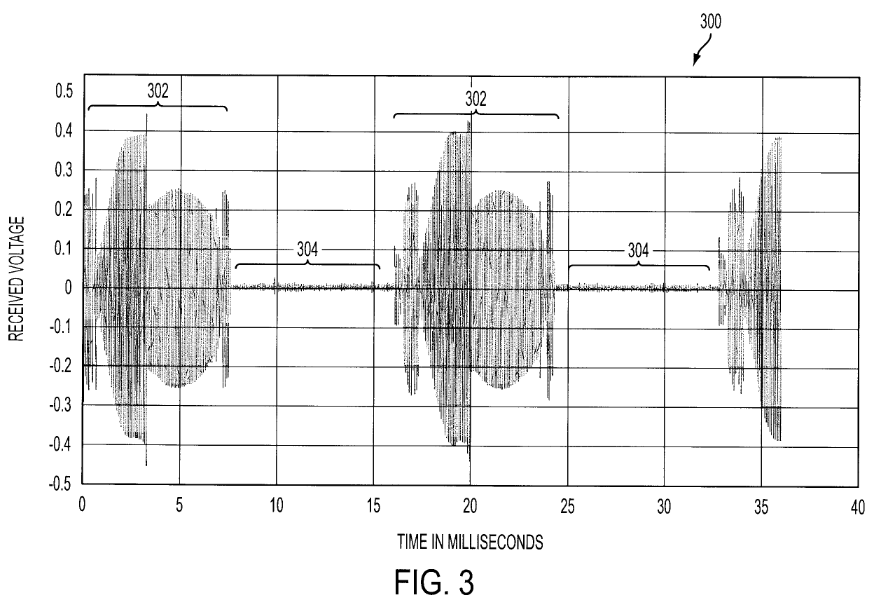

FIG. 3 illustrates a microwave oven signal 300 plotted with respect to time (measured in milliseconds). The microwave oven signal 300 comprises a series of ON periods, such as an ON period 302 and OFF periods, such as an OFF period 304 occurring alternately. The ON period 302 is characterized with an increase in power (sensed by increase in voltage received at transceiver of a wireless device) in wireless medium and the OFF period 304 is characterized with negligible power in the wireless medium (as can be seen in FIG. 3). It may be observed from plot of the microwave oven signal 300 that the ON period 302 and the OFF period 304 occur in a periodic manner. Typically, the ON period 302 and the OFF period 304 lasts for a duration of 6 milliseconds to 16 milliseconds depending on the frequency of the microwave oven signal 300. Typical frequencies used are 50 Hertz and 60 Hertz.

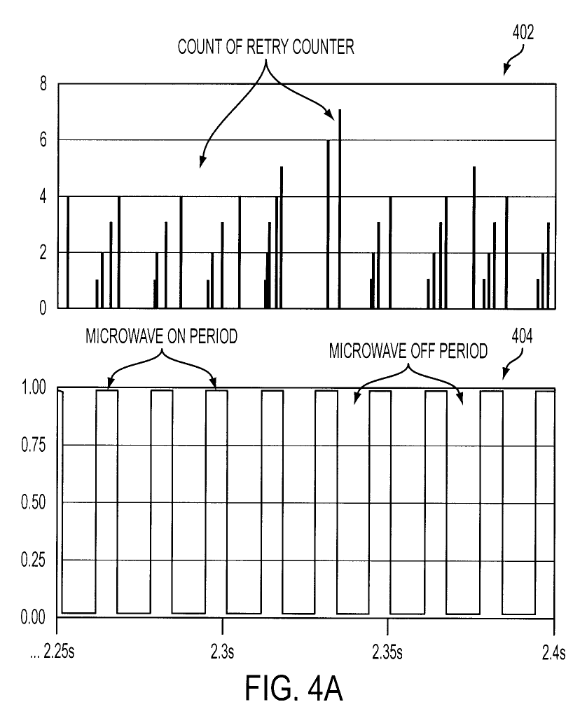

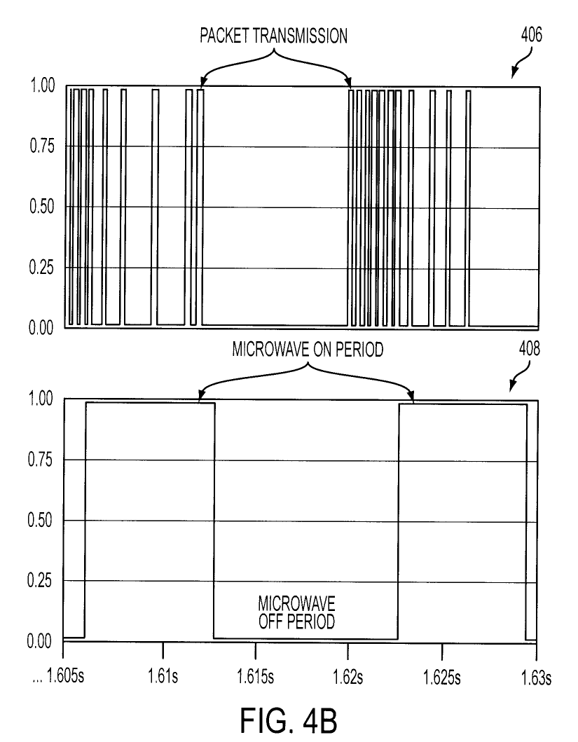

FIG. 4A illustrates change in a retry counter of a wireless device with respect to variation in power of a microwave oven signal. FIG. 4A comprises plot 402 and plot 404 depicting the change in count of the retry counter and the variation in power of the microwave oven signal respectively. The microwave oven signal follows an ON/OFF pattern, the ON period of microwave oven signal is depicted by a pulse (signifying an increase in power in wireless medium) and the OFF period is depicted by absence of pulse (signifying negligible power in the wireless medium) in plot 404. It may be observed from the plot 402 and the plot 404 that the count of the retry counter increases during the ON period of the microwave oven signal signifying repeated transmission of packets by the wireless device on account of failure of transmission of packets. The wireless device thus wastes significant amount of energy by transmitting packets during the ON period of microwave oven signal.

FIG. 4B illustrates variation in instances of packet transmissions by a wireless device in presence of a microwave oven signal. FIG. 4B comprises plot 406 and plot 408 depicting variation in the instances of packet transmissions by the wireless device and variation in power of the microwave oven signal respectively. In the plot 406, transmission of a packet is depicted as a pulse while absence of pulse signifies an idle period or a failure of transmission of packets. In a contention-based environment with wireless devices competing to transmit packets over a wireless medium, the failure of transmission of packets may result in doubling the size of a contention window for transmission of packets. The wireless device may then perform a backoff algorithm to compute number of time slots (corresponding to the size of the contention window) that the wireless device may have to wait for transmission of packets. It may be observed from the plots 406 and 408 that a large size of contention window (resulting from failure of transmissions) may overlap with OFF period of microwave oven signal and the wireless device may not transmit packets during the OFF period of the microwave oven signal. Thus the packets may be transmitted only during ON period of the microwave oven signal, resulting in packet loss and retransmission of the packets. From FIGS. 4A and 4B, it is evident that the wireless device needs to adapt transmission of the packets to transmit only during the OFF period of the microwave oven signal and avoid unnecessary retransmissions of the packets during the ON period of the microwave oven signal.

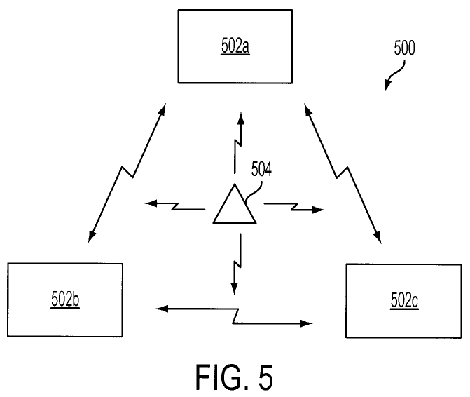

FIG. 5 illustrates an environment 500 in which various embodiments of the present disclosure may be practiced. The environment 500 comprises one or more wireless devices such as a wireless device 502a, a wireless device 502b and a wireless device 502c, and, an interference source such as interference source 504. The wireless devices 502a, 502b and 502c will hereinafter be collectively referred to as wireless devices 502. The wireless devices 502 may be in operative communication with each other or with an access point or a wireless router (not shown in FIG. 5). The wireless devices 502 communicate with each other by transmitting/receiving data in the form of data packets (hereinafter referred to as packets). The packets are sent over a wireless medium such as air at frequencies typically used for wireless communications. Typical frequency bands used for wireless communications are 2.4 Gigahertz (GHz) and 5 GHz frequency bands. Examples of the environment 500 may include a house, a neighborhood, an office setting and the like. Examples of the wireless devices 502 may include but are not limited to personal computers such as laptops and personal digital assistants (PDAs). An example of the interference source 504 may be a microwave oven or any such source of non-wireless fidelity (Wi-Fi) interference.

The wireless devices 502 typically comply with wireless standards such as 802.11 specifications for wireless communications. The 802.11 compliant wireless devices 502 typically use protocols such as Carrier Sense Multiple Access (CSMA) for transmission purposes. To prevent collisions, the wireless devices 502 may obey protocols such as CSMA/CA (Carrier Sense Multiple Access with Collision Avoidance) wherein a wireless device such as wireless device 502a informs other wireless devices 502 of intent to transmit. The interference source 504 may operate at an operating frequency defined for that particular type of device. For instance, the interference source 504 such as a microwave oven may operate in unlicensed Industry, Scientific and Medical (ISM) band thereby causing interference to packet transmissions from the wireless devices 502.

It will be obvious to the person skilled in the art, that the wireless device 502a may include a microcontroller for managing operations of the wireless device 502a, a memory module for storing instructions for operating the wireless device 502a, a storage module for storing packets in the wireless device 502a and a transceiver for transmitting/receiving packets. In accordance with an embodiment of the present disclosure, the wireless device 502a may be capable of triggering wireless spectrum sensing and may be further capable of sensing the wireless spectrum to determine the presence of a periodic interference signal. It will be evident to those skilled in the art that the microcontroller, the memory module, the storage module, module for triggering wireless spectrum sensing and module for sensing the wireless spectrum may be implemented as a hardware module, software module, firmware or any combination thereof.

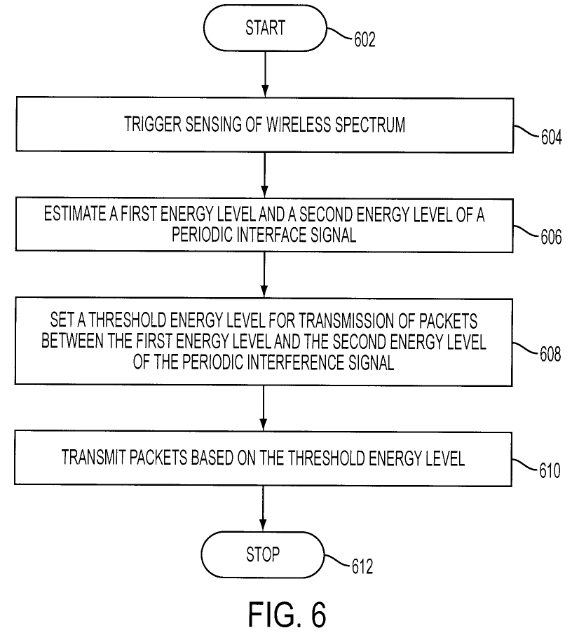

In accordance with an embodiment of the present disclosure, the wireless device 502a may track the status of transmission of packets by tracking changes in current contention window size or changes in count of a retry counter. A periodic change in the current contention window size or the count of the retry counter signifies a periodic pattern of transmission of packets, providing an indication of a possible presence of periodic interference signal. The wireless device 502a may then trigger sensing of wireless spectrum to determine the presence of the periodic interference signal. The sensing of the wireless spectrum may include scanning for wireless frequencies in the wireless medium, collecting radio frequency samples (RF I/Q samples) for enabling detection of the periodic interference signal and the like. Upon detecting presence of the periodic interference signal, the wireless device may then perform Media Access Control (MAC) adaptation to adapt transmission of packets to interference caused by the periodic interference signal. One such method for MAC adaptation is explained in conjunction with FIG. 6.

FIG. 6 is a flow diagram illustrating a method for adapting transmission of packets by a wireless device such as the wireless device 502a in response to interference in a wireless medium, in accordance with an embodiment of the present disclosure. The method initiates at 602, on reception of indication of a possible presence of a periodic interference signal. At 604, the wireless device triggers sensing of wireless spectrum for determining presence of the periodic interference signal. At 606, the wireless device estimates a first energy level and a second energy level of the periodic interference signal. At 608, the wireless device sets a threshold energy level between the first energy level and the second energy level for transmission of the packets. At 610, the wireless device transmits the packets based on the threshold energy level. The method ends at 612, when the wireless device adapts transmission of the packets to the interference present in the wireless medium by transmitting packets only when a current energy level in the wireless medium is lower than the threshold energy level.

In accordance with an embodiment of the present disclosure, the periodic interference signal is a microwave oven signal. A microwave oven operates by alternating between an activated status (hereinafter referred to as an ‘ON period’) and a deactivated status (hereinafter referred to as the ‘OFF period’). The microwave oven transmits the microwave oven signal only during the ON period. The absence of the microwave oven signal thus characterizes the OFF period. A pattern of alternate ON and OFF periods results in the periodic interference signal. On detecting interference, the wireless device 502a triggers sensing of the wireless spectrum to determine whether the interference is a periodic interference. On determining that the interference is the periodic interference signal (microwave oven signal), the wireless device 502a estimates a first energy level and a second energy level of the microwave oven signal. In one embodiment of the present disclosure, energy level corresponding to the ON period of the microwave oven signal may be the first energy level and the energy corresponding to the OFF period of the microwave oven signal may be the second energy level. It will be obvious to a person skilled in the art that the energy level corresponding to the ON period of the microwave oven signal may be chosen to be the second energy level and the energy level corresponding to the OFF period of the microwave oven signal may be chosen to be the first energy level.

It will be evident to those skilled in the art, that wireless devices, such as the wireless device 502a, perform clear channel assessment (CCA) by sensing the wireless medium to determine whether the medium is free of interference for transmission of the packets. Only on sensing a clear channel do the wireless devices transmit the packets. On estimating the energy level corresponding to the ON period of the microwave oven signal and the energy corresponding to the OFF period of the microwave oven signal, i.e. the first energy level and the second energy level respectively, the wireless device 502a sets a threshold energy level for clear channel assessment between the first energy level and the second energy level. The threshold energy level (CCA threshold) may be set to an appropriate power level, taking into consideration receiver sensitivity of a transceiver of the wireless device 502a, and may be chosen to sufficiently differentiate the ON period of the microwave oven signal from presence of any other form of energy (such as energy from other wireless device transmission) in the wireless medium.

To determine whether the wireless medium is free, the wireless device 502a estimates the current energy level in the wireless medium. The current energy level exceeding the threshold energy level indicates the energy level corresponding to the ON period of the microwave oven signal. The energy level corresponding to the ON period of the microwave oven signal signifies the presence of the periodic interference signal in the wireless medium. The wireless device refrains from transmitting the packets during the ON period of the microwave oven signal. The current energy level lower than the threshold energy level indicates the energy level corresponding to the OFF period of the microwave oven signal. The energy level corresponding to the OFF period of the microwave oven signal signifies the absence of the periodic interference signal and the wireless device 502a transmits the packets considering the channel free of interference from the microwave oven signal. Accordingly, the wireless device 502a adapts the transmission of the packets to the interference in the wireless medium and transmits the packets only when the current energy level is lower than the threshold energy level.

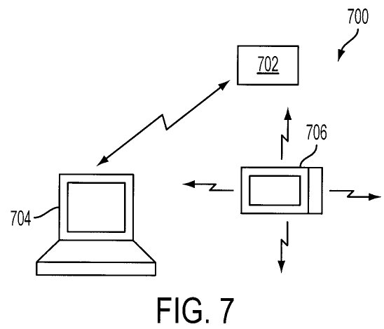

In accordance with another embodiment of the present disclosure, the wireless devices 502 freezes a timer countdown used for transmission in a contention based wireless system during the ON period and resumes the timer countdown only during the OFF period of the microwave oven signal. It will be evident to those skilled in the art that in the contention based system, the wireless devices compete for use of the wireless medium for transmission of packets and perform a backoff algorithm to determine a turn for each of the wireless devices 502 to transmit the packets. The timer countdown may be used by the wireless devices 502 to determine a time interval for transmission of the packets, computed on the basis of the backoff algorithm. The method for adapting transmission of packets by the wireless device in response to interference in a wireless medium will be explained in further detail using an exemplary environment in conjunction with FIG. 7.

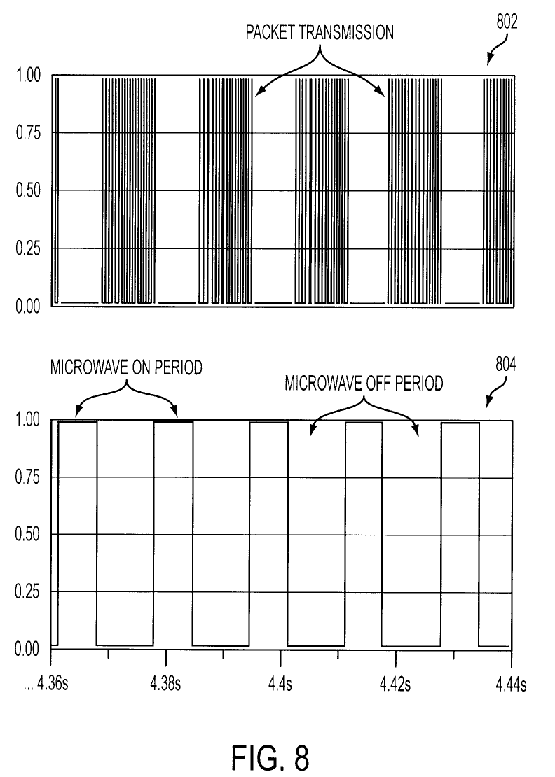

FIG. 7 depicts an exemplary environment 700, in accordance with an embodiment of the present disclosure. The exemplary environment 700 comprises an access point 702, a personal computer 704 (such as wireless device 502a) and a microwave oven 706. The microwave oven 706 (such as the interference source 504) serves as a source of periodic interference signal. The personal computer 704 is in operative communication with the access point 702, exchanging packets with the access point 702. The periodic interference signal from the microwave oven 706 causes interference to reception of packets by the personal computer 704. FIGS. 8-10 depict the results of the simulations performed in the exemplary environment 700 using the method described in conjunction with FIG. 6 (hereinafter referred to as MAC adaptation method).

FIG. 8 illustrates change in packet transmissions with respect to variation in power of a microwave oven signal in an exemplary environment such as the exemplary environment 700, in accordance with an embodiment of the present disclosure. FIG. 8 comprises plot 802 and plot 804 depicting the change in pattern of packet transmissions by the personal computer 704 and variations in power of the microwave oven signal, respectively. In the plot 802, transmission of a packet is depicted as a pulse. The absence of pulse in the plot 802 signifies an idle period or a failure of transmission of packets. It may be observed from the plot 802 and the plot 804 that by performing the MAC adaptation method, the wireless device transmits packets only during the OFF period of the microwave interference signal and refrains from transmitting during the ON period of the microwave oven signal, thereby conserving energy by avoiding retransmissions.

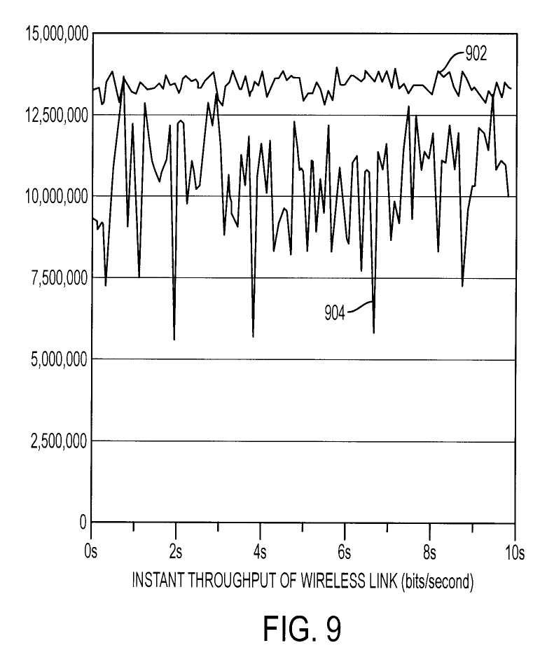

FIG. 9 illustrates instant throughput performance of a wireless link in an exemplary environment such as the exemplary environment 700, in accordance with an embodiment of the present disclosure. FIG. 9 comprises plot 902 and plot 904 depicting the instant throughput performance of the wireless link in the exemplary environment 700 by using the MAC adaptation method and without using the MAC adaptation method, respectively. It may be observed from the plot 902 and the plot 904 that by using the MAC adaptation method, the instant throughput performance (measured in bits per second) is improved as compared to transmission of the packets without using the MAC adaptation method.

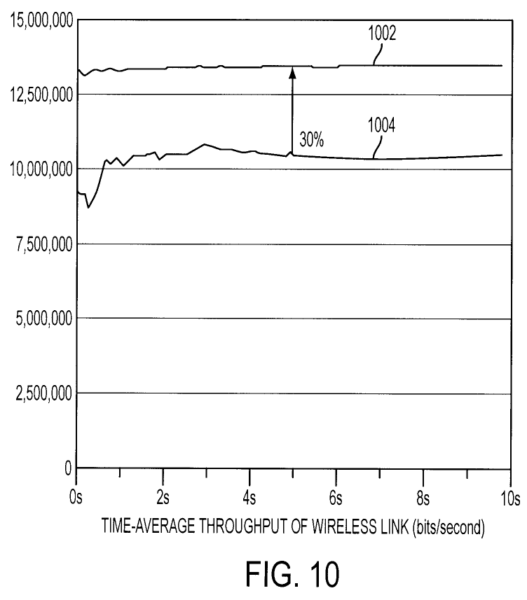

FIG. 10 illustrates time-average throughput performance of a wireless link in an exemplary environment such as exemplary environment 700, in accordance with an embodiment of the present disclosure. FIG. 10 comprises plot 1002 and plot 1004 depicting the time-average throughput performance of the wireless link in the exemplary environment 700 by performing the MAC adaptation method and without performing the MAC adaptation method, respectively. It may be observed from the plots 1002 and the plots 1004 that by performing the MAC adaptation method, the time-average throughput performance (measured in bits per second) improves by approximately 30 percent as compared to time-average throughput without performing the MAC adaptation method. Further, it may be observed that a wireless link is comparatively stable and has less jitter using the MAC adaptation method as compared to wireless link performance without using the MAC adaptation method.

The MAC adaptation method may lead to significant power saving as the wireless device transmits packets only during the OFF period of the periodic interference signal, thereby avoiding wastage of energy in retransmission of packets. The MAC adaptation method may be used to achieve higher throughput, especially in digital home environments and enterprise environments prone to interference by microwave signal (such as a microwave oven signal). For instance, the MAC adaptation method may be used to achieve better network utilization in an enterprise environment or send significantly jitter-less video over a wireless link in a digital home environment. Further, the MAC adaptation method makes use of sensing capability of silicon in network interface cards (NIC). Furthermore, the method is highly cost-effective and precludes the need of end-to-end support such as the support from vendors for access points.

As described above, the embodiments of the present disclosure may be embodied in the form of computer-implemented processes and apparatuses for triggering a wireless device to perform sensing of wireless spectrum for detecting interference in a wireless medium. Embodiments of the disclosure may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the present disclosure. The present disclosure may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented on a general-purpose microprocessor, the computer program code segments configure the microprocessor to create specific logic circuits.

The foregoing descriptions of specific embodiments of the present disclosure have been presented for purposes of illustration and description. They are not intended to be exhaustive or to limit the disclosure to the precise forms disclosed, and obviously many modifications and variations are possible in light of the above teaching. The embodiments were chosen and described in order to best explain the principles of the disclosure and its practical application, to thereby enable others skilled in the art to best utilize the disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A method for adapting transmission of packets by a wireless device in response to interference in a wireless medium, the method comprising:
sensing of wireless spectrum by the wireless device for determining presence of a periodic interference signal;
estimating a first energy level and a second energy level of the periodic interference signal by the wireless device;
setting a threshold energy level for transmission of packets between the first energy level and the second energy level; and
transmitting the packets by the wireless device, wherein the wireless device transmits the packets based on the threshold energy level.

2. The method of claim 1 further comprising determining a current energy level in the wireless medium and transmitting the packets based on the threshold energy level and the current energy level.

3. The method of claim 1, wherein the wireless device is an 802.11 compliant device.

4. The method of claim 1, wherein the interference is non wireless fidelity (Wi-Fi) interference.

5. The method of claim 1, wherein the periodic interference signal is a microwave oven signal.

6. The method of claim 1, wherein the first energy level corresponds to an ON period of the periodic interference signal.

7. The method of claim 1, wherein the second energy level corresponds to an OFF period of the periodic interference signal.

8. The method of claim 1, wherein the threshold energy level is a clear channel assessment (CCA) threshold for transmission of the packets.

9. A computer program product embodied on a computer readable medium for adapting transmission of packets by a wireless device in response to interference in a wireless medium, the computer program product comprising a program module having instructions for:
sensing of wireless spectrum by the wireless device for determining presence of a periodic interference signal;
estimating a first energy level and a second energy level of the periodic interference signal by the wireless device;
setting a threshold energy level for transmission of packets between the first energy level and the second energy level; and
transmitting the packets by the wireless device, wherein the wireless device transmits the packets based on the threshold energy level.

10. The computer program product according to claim 9 further comprising instructions for determining a current energy level in the wireless medium and transmitting the packets based on the threshold energy level and the current energy level.

11. The computer program product of claim 9, wherein the wireless device is an 802.11 compliant device.

12. The computer program product of claim 9, wherein the interference is non wireless fidelity (Wi-Fi) interference.

13. The computer program product of claim 9, wherein the periodic interference signal is a microwave oven signal.

14. The computer program product of claim 9, wherein the first energy level corresponds to an ON period of the periodic interference signal.

15. The computer program product of claim 9, wherein the second energy level corresponds to an OFF period of the periodic interference signal.

16. The computer program product of claim 9, wherein the threshold energy level is a clear channel assessment (CCA) threshold for transmission of the packets.
